(19) United States
(12) Patent Application Publication
(10) Pub. No.: US 2026/0295731 A1
(43) Pub. Date: Oct. 1, 2026

(54) METHOD AND DEVICE FOR LASER CLADDING WITH A PRIMARY AND A SECONDARY LASER ENERGY

(71) Applicant: TRUMPF Laser- und Systemtechnik SE, Ditzingen (DE)

(72) Inventors: Tim Hesse, Ditzingen (DE); Nicolai Speker, Pleidelsheim (DE); Bjoern Sautter, Leonberg (DE); Andreas Scholz, Taunusstein (DE); Julius Irrek, Ditzingen (DE); Timo Steeb, Leonberg (DE); Anna Schulz, Lauterbach (DE); Ralf Eckardt, Rutesheim (DE); Niels Schäfer, Stuttgart (DE)

(21) Appl. No.: 19/678,192

(22) Filed: May 15, 2026

Related U.S. Application Data
(63) Continuation of application No. PCT/EP2024/082561, filed on Nov. 15, 2024.

(30) Foreign Application Priority Data
Nov. 20, 2023 (DE) 10 2023 132 189.7

(51) Int. Cl. B23K 26/342; B23K 26/067; B23K 26/08; B23K 26/14; B23K 26/144

(52) U.S. Cl. CPC B23K 26/342; B23K 26/067; B23K 26/0823; B23K 26/0869; B23K 26/144; B23K 26/1462

(57) ABSTRACT

A method for laser cladding along a feed direction by a jet nozzle includes directing a first laser beam at a workpiece to produce a first irradiation zone and directing a second laser beam at the workpiece to produce a second irradiation zone. The second irradiation zone is upstream of the first irradiation zone in the feed direction. The method further includes introducing a filler material into the first irradiation zone. The filler material at least partially enters the first laser beam before hitting the workpiece and is at least partially heated as a result. The first laser beam introduces a primary laser energy into the first irradiation zone. The second laser beam introduces a secondary laser energy into the second irradiation zone. The secondary laser energy is greater than the primary laser energy.

### CROSS REFERENCE TO RELATED APPLICATIONS

This application is a continuation of International Application No. PCT/EP2024/082561 (WO 2025/108849A1), filed on Nov. 15, 2024, and claims benefit to German Patent Application No. DE 10 2023 132 189.7, filed on Nov. 20, 2023. The aforementioned applications are hereby incorporated by reference herein.

### FIELD

Embodiments of the present invention relate to a method for laser cladding along a feed direction and to a jet nozzle for laser cladding.

### BACKGROUND

Laser cladding is used in the fields of repair, coating, and/or joining technology, for example. A distinction can be drawn between conventional laser cladding techniques (laser metal deposition (LMD), direct metal deposition (DMD) or direct energy deposition (DED)), and high-speed laser metal deposition (HS-LMD) or extreme high-speed laser application (EHLA). HS-LMD methods are described, for example, in published patent applications DE 10 2011 100 456 A and DE 10 2018 130 798 A1. Furthermore, the patent application DE 10 2022 100 173 A1 discloses a method for additive manufacturing in which a first laser beam from a nozzle unit and a second laser beam originating from a separate head are directed onto a workpiece in order to additively apply a powdered construction material.

A functional layer can be applied to a workpiece by means of laser cladding. This generally increases the load-bearing capacity of the workpiece processed by means of laser cladding compared to an unprocessed workpiece. The functional layer can serve as a wear protection layer, for example. The application of the functional layer can be based on a diffusion process, a melting on and/or melting of a workpiece surface, an application of a filler material, and a subsequent cooling, so that a matrix structure with hard material particles is materially bonded to the material surface. Laser cladding affects and alters the internal material structure of the workpiece and the material being applied. This can potentially lead to imperfections in the internal material structure, such as cracks and/or bonding defects. It is also possible that the hard particles form an alloy with the matrix material, causing the matrix structure and thus the applied functional layer to become brittle. These imperfections can impair the desired increase in load-bearing capacity. They are generally microscopic in nature, which is why they and the underlying cause can only be identified with great effort.

### SUMMARY

Embodiments of the present invention provide a method for laser cladding along a feed direction by a jet nozzle. The jet nozzle includes a light channel for conducting at least one laser beam to be directed at a workpiece, and a powder unit for conducting at least one filler material, to be applied to the workpiece. The method includes directing a first laser beam at the workpiece to produce a first irradiation zone and directing a second laser beam at the workpiece to produce a second irradiation zone. The second irradiation zone is upstream of the first irradiation zone in the feed direction. The method further includes introducing the filler material into the first irradiation zone. The filler material at least partially enters the first laser beam before hitting the workpiece, and is at least partially heated as a result. The first laser beam introduces a primary laser energy into the first irradiation zone. The second laser beam introduces a secondary laser energy into the second irradiation zone. The secondary laser energy is greater than the primary laser energy.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a jet nozzle during laser cladding with a first irradiation zone and a second irradiation zone according to some embodiments;

FIG. 2 shows a schematic view of laser optics for generating the first irradiation zone and the second irradiation zone according to some embodiments;

FIG. 3 shows a microscopic view of a functional layer applied using conventional laser cladding methods and a functional layer applied using the method according to embodiments of the present invention;

FIG. 4 shows a schematic top view of a brake disk onto which a powder-layer trace was applied along a spiral path according to some embodiments;

FIG. 5 shows a schematic cross-section through a brake disk onto which a first powder-layer trace (top) and further powder-layer traces (bottom) have been applied according to some embodiments;

FIG. 6a and FIG. 6b show a schematic top view of a brake disk onto which a first powder-layer trace (left) and further powder-layer traces (right) have been applied according to some embodiments;

FIG. 7 shows a perspective view of a jet nozzle from above, into which powder injectors are inserted, according to some embodiments;

FIG. 8 shows a perspective view of a jet nozzle from below according to some embodiments; and

FIG. 9 shows a schematic view of an interaction between a filler material and a first laser beam and a lack of interaction between the filler material and a second laser beam according to some embodiments.

### DETAILED DESCRIPTION

Embodiments of the present invention provide an improved method as well as an improved jet nozzle for laser cladding along a feed direction. In particular, embodiments of the invention apply the filler material to the workpiece in such a way that the imperfections in the internal material structure are reduced or even avoided, and the welding quality of the applied functional layer and the workpiece as a whole is increased. The imperfections can be bonding defects between the material surface and the applied functional layer or between individual applied functional layers. The imperfections can also be pores, i.e., air pockets, which occur within the applied functional layer, or between the applied functional layer and the material surface. Particularly if the material surface is a cast material, pores can occur more frequently. The imperfections can also be cracks that run vertically to the material surface within the applied functional layer. The imperfections can also result from the fact that powder particles, in particular carbides, of the powdered filler material dissolve in a matrix material of the powdered filler material, thus forming an alloy, which leads to the matrix material becoming brittle. Embodiments of the present invention also provide a reliable jet nozzle that enables the application of the functional layer in accordance with the process. According to embodiments of the invention, the jet nozzle is configured in such a way that it ensures reliable and precise laser cladding over a very high number of cycles.

A method for laser cladding along a feed direction by means of a jet nozzle is accordingly proposed. Laser cladding can be a method for high-speed laser metal deposition (HS-LMD). The feed direction is the direction along which the jet nozzle moves relative to a workpiece. It can result from a movement, in particular a rotational movement, of the workpiece, from a movement of the jet nozzle, or from a superposition of both movements. The workpiece can be a rotationally symmetrical workpiece, such as a brake disk, a hydraulic cylinder, a pressure roller, or a plain bearing. The jet nozzle has a light channel for conducting at least one laser beam, which is directed at a workpiece. The light channel can be a hollow channel that runs through the entire jet nozzle along a longitudinal direction. In addition to the laser beam, a process gas can also be directed to the workpiece surface through the light channel. The jet nozzle further comprises a powder unit, in particular arranged radially outside the light channel, for conducting at least one filler material, in particular a powder or alternatively a wire, wherein the filler material is intended to be applied to the workpiece. Starting from the longitudinal direction of the jet nozzle, the powder unit can be radially outside the light channel and can be part of an outer structure that surrounds the light channel in a closed manner. The powder jet can conduct at least one powdered filler material consisting of hard material particles, in particular carbides, and a matrix material. The powder unit can be the part of the jet nozzle that is provided to directly or indirectly conduct the powdered filler material. The powder unit can have injector guides into which powder injectors can be inserted. It can also have an annular gap within which the powdered filler material is conducted.

The method comprises the step of directing a first laser beam onto the workpiece in order to produce a first irradiation zone. The first laser beam can be used to heat and, in particular, to at least partially melt the filler material and the workpiece. The thermal energy transported by the first laser beam, i.e., the primary laser energy, can therefore be used to melt the filler material and the workpiece in the manner desired for laser cladding. The first irradiation zone can therefore be called the process zone, as this is where the desired process of applying the functional layer to the workpiece takes place.

The method also includes the step of directing a second laser beam onto the workpiece in order to produce a second irradiation zone. The second laser beam can be used to preheat the workpiece. The thermal energy transported by the second laser beam, i.e., the secondary laser energy, can therefore be used to preheat the workpiece or the substrate to be coated before melting. The second irradiation zone can therefore be called the preheating zone, as the substrate to be coated is preheated here. The second laser beam can be directed in such a way that it does not interact with the filler material before it hits the workpiece, or only interacts to a negligible extent.

The second irradiation zone is upstream of the first irradiation zone in the feed direction, so that the first irradiation zone follows the second irradiation zone. The second irradiation zone can be located immediately before the first irradiation zone, so that as little time as possible elapses between preheating and melting.

The method further comprises the step of introducing the filler material into the first irradiation zone, the filler material at least partially entering the first laser beam before hitting the workpiece, and being at least partially heated as a result. Heating the filler material with the first laser beam can improve the melting behavior of the filler material on the workpiece. The filler material can be introduced around the first laser beam, for example along the shape of a partial circle or a partial elongated hole.

According to embodiments of the invention, the secondary laser energy introduced into the second irradiation zone by the second laser beam is greater than the primary laser energy introduced into the first irradiation zone by the first laser beam. The higher secondary laser energy can result from a higher irradiation intensity of the laser beam (in W/cm²). It can also be caused by a laser wavelength that has a higher absorption on the workpiece. This can be done in particular using diode laser radiation, which is at about 800 nm for aluminum and at around 515 nm or 450 nm for copper. The thermal energy introduced into the preheating zone thus exceeds the thermal energy introduced into the process zone. Embodiments of the invention thus deviate from the principle widely held in the present field that more energy is required for the actual process, namely the application, than for an accompanying phenomenon, namely the preheating. Thus, the thermal input into the filler material can be large enough to promote melting, without the risk of hard particles forming an alloy with the matrix, which has been identified as the cause of a brittle, cracked matrix.

Embodiments of the invention is therefore based on a heat management system in which less energy is used for heating and partially melting the filler material before it hits the workpiece than for preheating the workpiece. By preheating the workpiece relatively intensely using higher secondary laser energy than primary laser energy, heat transfer from the heated filler material to the workpiece after its application is reduced. The reduced heat transfer from the filler material to the workpiece, for example in the form of molten powder, can mean it is not absolutely necessary to form a weld pool, in particular a homogeneous weld pool, in either the first irradiation zone or in the second irradiation zone in order to ensure that the functional layer is applied to the workpiece without imperfections. With sufficiently high secondary laser energies, it is also possible that a weld pool can form on the workpiece surface as early as the second laser beam, i.e., before the powder jet hits the workpiece. Furthermore, the reduced primary laser energy can cause the filler material in the process zone to only experience partial preheating. The direct energy input to the filler material and the hard particles contained therein is therefore relatively low compared to the indirect heat input from the preheated workpiece into the filler material. The indirect heat input enables a gentle, uniform bonding of the filler material to the workpiece and, if applicable, a previously applied layer, therefore also with a lower temperature gradient. This gentle and uniform manufacturing process reduces the risk of hard particles forming an alloy with the matrix material and thus contributing to a brittle and/or cracked functional layer.

The first laser beam and/or the second laser beam can use a disk laser or a fiber laser as a laser source. A diode laser can also be used. In this way, for example, laser beams with wavelengths of around 450 nm, of around 515 nm, between around 800 nm and around 1000 nm, or of around 1030 nm, 1060 nm or 1070 nm can be generated. The respective laser beam can be arranged such that it can be guided to a processing head by means of an optical fiber. Owing to large usable fiber diameters, the laser beam can be satisfactorily coupled into a comparatively large ring and core portion of a multi-clad fiber, as described in more detail below, for example in the case of limited brilliance of the diode emitters or bars or stacks. The laser source can have a laser power of between 2 kW and 100 kW. If the workpiece is a brake disk, the laser power can in particular be between 8 kW and 50 kW. If the workpiece is a plain bearing, the laser power can in particular be 2 kW. The laser beam can be directed substantially orthogonally onto a surface to be processed of the workpiece. The powder jet can be inclined in relation to the laser beam in order to form an interaction zone between the powder jet and the laser beam above the material surface. Such an interaction zone enables more efficient deposition of the pulverulent material onto the workpiece.

In one embodiment, the second laser beam has a higher laser power and/or a higher irradiation intensity in W/cm² and/or a larger cross-sectional area in cm² compared to the first laser beam. The increased secondary laser energy compared to the primary laser energy can be achieved geometrically by separating a larger area from the laser output beam for the second laser beam. It can also be achieved by providing the first laser beam and the second laser beam with different laser sources. The cross-sectional area of the first laser beam and/or the second laser beam can be adjusted using a suitable focusing lens. This helps to avoid cracking and/or bonding defects through optimized thermal treatment.

In one embodiment, the ratio of the secondary laser energy to the primary laser energy is greater than 11:10, in particular 5:4, more particularly 3:2. It has been found that under these conditions there is an optimal balance between sufficient heating of the filler material and subsequent melting by the first laser beam and sufficient thermal energy in the second irradiation zone. This prevents hard particles forming alloys in the surrounding metallic material.

In one embodiment, the method further comprises the step of actuating a workpiece receiving unit, on which the workpiece is arranged, so that a rotational movement moves the workpiece about an axis of rotation. The actuation can take place between a central control unit of the laser system and a local control unit of a processing unit. The workpiece receiving unit can clamp the workpiece such that it is firmly mounted therein, provided that the workpiece receiving unit is itself rotatable. The axis of rotation can correspond to an axis of rotational symmetry of the rotationally symmetrical workpiece. The jet nozzle can be directed at a location on the workpiece that lies radially outside the axis of rotational symmetry thereof. Thus, rotation about the axis of rotation causes the powder-layer trace to follow a path on the workpiece. Rotational movement of the workpiece receiving unit can be initiated by an independent drive.

The method further comprises the step of actuating a translation unit, so that a translational movement moves the jet nozzle and/or the workpiece receiving unit in an offset direction substantially orthogonal to the axis of rotation. The translational movement can be initiated by a drive that is separate from the workpiece receiving unit. Alternatively, the translational movement can be initiated by the same drive as the rotational movement. An orthogonal offset direction of the translational movement can bring about translation orthogonal to the axis of rotation, which can accordingly have an effect on a path of a powder-layer trace. The rotational movement can be very significant compared to the translational movement.

The rotational movement and the translational movement combine to form an advancing movement, such that a powder-layer trace having a radial trace width is deposited onto the workpiece along a spiral path. This enables extensive powder coating in a radial direction of the workpiece. The geometric shape of the spiral path is determined by the advancing movement. The advancing movement can influence process parameters, such as for example the duration of action between powder jet, laser beam and workpiece, to enable robust bonding of the pulverulent particles with the workpiece. The spiral path extends along a curve about the axis of rotation, with the distance from the axis of rotation increasing if deposition proceeds from radially inside to radially outside, or decreasing if deposition proceeds from radially outside to radially inside. The rotational movement results from a rotational speed, while the translational movement results from a translational speed. If the processing parameter is the advancing movement, variation results from a variation in rotational and/or translational speed.

An offset of two adjacent spiral flanks of the spiral path is less than the trace width, so that the powder-layer trace forms a radial overlap along the spiral path. Thus, when depositing from radially inside to radially outside, one radially inner powder-layer trace is arranged under at least the next radially outer powder-layer trace. In particular, a first single trace of the powder-layer trace can be superimposed on several, for example three, four, five or six further traces of the powder-layer trace to form a powder layer. Accordingly, when depositing from radially outside to radially inside, one radially outer powder-layer trace is arranged under the next radially inner powder-layer trace. This radial overlap increases the powder layer thickness because at least partially overlaid powder-layer traces, i.e., overlapping powder-layer traces, have a greater powder layer thickness than two powder-layer traces whose offset is greater than their radial trace width.

In one embodiment, the ratio of the trace width to the offset is greater than 2:1, in particular 5:1 or even 15:1. This ensures an appropriate thickness of the applied functional layer. The ratio of the trace width to the offset allows adjustment of both the resulting layer thickness of the functional layer and the process speed of laser cladding. The above conditions enable a reliable, sufficiently thick functional layer with efficient processing times.

In one embodiment, the radial overlap and the feed movement are designed such that, when applying along the spiral path, the second laser beam reheats a previously applied powder-layer trace in order to promote its welding behavior by means of post-processing, in particular reheating. The second irradiation zone caused by the second laser beam, i.e., the preheating zone, can thus simultaneously create a reheating zone for an adjacent spiral flank. The second irradiation zone thus not only promotes the application of a single trace, but also contributes to a gentle cooling phase, i.e., a cooling phase with a low temperature gradient, of the adjacent spiral flank.

In one embodiment, the first laser beam and/or the second laser beam has a reduced intensity in a core region of the respective laser beam compared to a border region of the respective laser beam. For example, the core intensity can be less than 90% of the border intensity. Thus, at least within the interaction zone, the laser beam has an intensity in a border region which is higher than an intensity in the core region of the laser beam, so that the filler material is subjected to the higher intensity of the border region when it enters the interaction zone. Due to an inclined direction of the at least one powder jet with respect to the laser beam, the interaction section with the laser beam varies over the cross-section of the powder jet. Due to the reduced intensity in the core region, a substantially homogeneous energy is supplied to the individual powder particles over a varying interaction section. In other words, an intensity maximum in the border region of the laser beam leads to a more even distribution of the fluence per powder particle and thus to an enlargement of the process window through to higher laser powers together with a more stable welding quality. For the intensity distribution of the laser beam in the focal plane, it can hold true that: Iborder≥Icenter≥0.

In one embodiment, the first laser beam and/or the second laser beam has a plateau-shaped intensity distribution. The plateau shape can also be referred to as a top hat. The plateau-or top hat-shaped intensity distribution describes a sudden rise in the intensity at the border of the laser beam to the intensity maximum, which is maintained substantially over the entire width of the border region, before the intensity suddenly drops back again in the direction toward the core region of the laser beam. The plateau-or top hat-shaped intensity distribution in the border region of the laser beam promotes a reduction in the roughness of the applied material layer compared to a Gaussian intensity distribution. At least at one location within the interaction zone, the intensity in the core region of the laser beam can be at most 90%, preferably at most 50%, even more preferably at most 10% of the intensity maximum in the border region of the laser beam. The intensity distribution with a lowered intensity in the core region of the laser beam makes it possible to enlarge the process window with regard to the variability of the laser power used. In particular, the described intensity distribution in the focal plane allows laser powers>4 kW to be used while maintaining the welding quality, because more laser power is used to preheat and/or melt the powder for coating the workpiece. At least at one location within the interaction zone, the power in the core region of the laser beam can be, for example, between 7% and 9% of the laser power of the overall laser beam. In the core region, it can also be between 5% and 7%, in particular around 6% of the overall power of the laser beam. According to an alternative variant, the power in the core region can be reduced to a minimum, which is to say amount in particular to 0% of the overall laser power.

In one embodiment, the first laser beam and the second laser beam are generated from a common laser output beam via beam splitting in a common optical unit. This simplifies the assembly of the laser system and allows for a space-saving arrangement. The beam splitting occurs in particular by means of an optical wedge, a cylindrical lens and/or a diffractive optical element (DOE). Facet optics or a microlens array can also be used as a beam splitter element. By means of the optical wedge and the DOE, as well as facet optics or a microlens array, separate partial beams can be generated, by means of which the workpiece surface is exposed to the respective irradiation zone. Using the cylindrical lens, an elliptical beam profile of the laser beam can be generated so that the laser beam irradiates the respective irradiation zones on the workpiece surface with a continuous beam spot. A displacement unit can be further comprised, by means of which the optical element designed as an optical wedge or as a DOE can be displaced laterally in the beam path of the laser output beam to distribute the laser power to the resulting laser beams.

In one embodiment, the first laser beam and the second laser beam can be provided from two separate laser beam sources, in particular by means of two separate laser optics, wherein the second laser beam is supplied to the second irradiation zone outside the light channel. Thus, the provision of the laser beam can already take into account the intended irradiation energy of the respective irradiation zone.

In one embodiment, a protective gas is conducted in the light channel, by means of which the first irradiation zone and/or the second irradiation zone are shielded from ambient oxygen. The protective gas can surround the first laser beam and/or the second laser beam in a ring shaped manner to prevent unwanted oxidation in the first irradiation zone and/or the second irradiation zone.

In one embodiment, the filler material is introduced into the first irradiation zone by means of powder injectors. The powder injectors can be embedded in corresponding injector guides in the powder unit of the jet nozzle. The powder injectors enable a high degree of precision in the guidance of the filler material in accordance with the process. The desired separation of the powder focus and the preheating zone by the second laser beam can be achieved particularly efficiently using powder injectors.

The disclosure further relates to a jet nozzle for laser cladding along the feed direction. The jet nozzle has a light channel for conducting at least one laser beam, which is directed at a workpiece. The workpiece can be a rotationally symmetrical workpiece, such as a brake disk, a hydraulic cylinder, a pressure roller, or a plain bearing. The light channel can be a hollow channel that runs through the entire jet nozzle along a longitudinal direction. In addition to the laser beam, a process gas can also be directed to the workpiece surface through the light channel. The jet nozzle also has a powder unit arranged in particular radially outside the light channel for conducting at least one filler material, in particular a powder or a wire, which is to be applied to the workpiece. Starting from the longitudinal direction of the jet nozzle, the powder unit can be radially outside the light channel and can be part of an outer structure that surrounds the light channel in a closed manner. The powder jet can conduct at least one powdered filler material consisting of hard material particles, in particular carbides, and a matrix material. The powder unit can be the part of the jet nozzle that is provided to directly or indirectly conduct the powdered filler material. The powder unit can have injector guides into which powder injectors can be inserted. It can also have an annular gap within which the powdered filler material is conducted.

The jet nozzle is configured and intended to perform the method according to the disclosure. It can be coupled by means of a control unit that specifies the primary laser energy and the secondary laser energy in such a way that the application of filler material with the thermal management optimized according to the disclosure is made possible.

In one embodiment, the jet nozzle is manufactured by means of an additive manufacturing process, in particular by means of powder bed fusion. For this purpose, the jet nozzle can be made of copper or a copper alloy, in particular a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion can be formed using selective laser melting (SLM) or selective laser sintering (SLS), for example. The jet nozzle can be made of a non-ferromagnetic and/or non-ferromagnetizable material.

The features according to the disclosure contribute partly on their own and partly in combination to overcoming the imperfections of laser cladding mentioned at the outset.

Preferred exemplary embodiments are described below with reference to the figures. In this respect, elements that are the same, similar, or have the same effect are provided with identical reference signs in the various figures, and a repeated description of these elements is omitted in some instances to avoid redundancies.

FIG. 1 shows a jet nozzle 1 for laser cladding along a feed direction 2. The feed direction 2 is the direction along which the jet nozzle 1 moves relative to a workpiece 100. It can result from a movement, in particular a rotational movement, of the workpiece 100, from a movement of the jet nozzle 1 or from a superimposition of a movement of the workpiece 100 and the jet nozzle 1. The feed direction 2 and the correlating advance movement can be constant over the course of the process. Alternatively, they can vary with the respective process stage. The workpiece 100 can be a rotationally symmetrical workpiece, such as a brake disk, a hydraulic cylinder, a pressure roller, or a plain bearing.

The jet nozzle 1 has a light channel 3 for conducting a laser output beam 50, which consists of a first laser beam 51 and a second laser beam 52. The first laser beam 51 and the second laser beam 52 can be attributed to the same laser source or alternatively to two different laser sources. The light channel 3 has a lateral surface 4 within which the laser output beam 50 is conducted. There is an outer structure 5 radially outside the light channel 3. In the region of one end of the jet nozzle 1 facing a workpiece 100, a nozzle mouth 6 forms a powder unit 7. Injector guides 8 can be formed within the powder unit 7, into which a powder injector 9 can each be inserted.

The first laser beam 51 is directed at the workpiece 100 and forms a first irradiation zone 101. The second laser beam 52 is also directed at the workpiece 100 and produces a second irradiation zone 102. The second irradiation zone 102 is upstream of the first irradiation zone 101 in the feed direction 2. The powder unit 7 introduces a filler material 60 into the first irradiation zone 101, the filler material 60 at least partially entering the first laser beam 51 before hitting the workpiece 100, and being partially heated as a result. A secondary laser energy introduced into the second irradiation zone 102 by the second laser beam 52 is greater than a primary laser energy introduced into the first irradiation zone 101 by the first laser beam 51.

The laser output beam 50, which is composed of the first laser beam 51 and the second laser beam 52, can therefore exit from the jet nozzle 1. When the first laser beam 51 is irradiating a workpiece surface (not shown), the first irradiation zone 101 is produced on the workpiece surface and the second laser beam 52 produces the second irradiation zone 102 in an analogous manner. By means of a relative movement of the workpiece 100 to be coated and the jet nozzle 1, the laser beams 51, 52 are moved in the feed direction 2 along a predetermined processing path over the workpiece surface. The powdered filler material 60 is also irradiated in the first laser beam 51 via the jet nozzle 1 so that the powder particles irradiated by the first laser beam 51 are heated and impinge on the workpiece surface along the processing path in the first irradiation zone 101, also known as the process zone. Due to the simultaneous heating of the powder particles and the workpiece surface in process zone 101, a solid bond is formed very quickly when the powder particles impinge on the workpiece surface. In this case, a partial weld pool can be formed instead of a complete weld pool. The partially molten material deposit in the process zone 101 subsequently solidifies into a trace in the form of a weld bead 61. To accelerate the coating process and at the same time minimize the occurrence of bonding defects, the workpiece surface is pre-heated by the second laser beam 52 in the second irradiation zone 102, also known as the pre-heating zone, in the run-up to the process zone 101. In order to further improve the bonding of the material deposition of the filler material 60 to the workpiece 100 or the bonding of overlapping paths of the material deposition, the weld bead 61 can also be heated in a third irradiation zone following the process zone 101, which is produced by irradiation using a third laser beam (not shown). The first laser beam 51 and/or the second laser beam 52 can have a reduced core intensity.

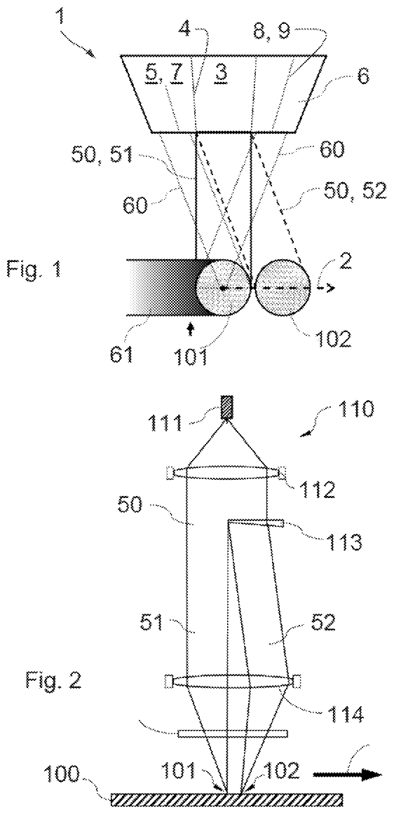

FIG. 2 schematically shows the structure of laser optics 110 which can be used in a laser system having the jet nozzle 1. The laser optics 110 can in particular be arranged in a processing head of the laser system. A laser output beam 50 is collimated onto a collimation unit 112, in particular a collimation lens, via a fiber optic cable 111, for example with a 2-in-1 fiber. A beam splitter element 113, in particular in the form of an optical wedge, is arranged in the beam path of the collimated laser output beam 50. The beam splitter element 113 can be moved transversely to the propagation direction of the laser output beam 50 and thus split the laser output beam 50 into the first (partial) laser beam 51 and the second (partial) laser beam 52 in accordance with the process. For example, by the lateral positioning of the beam splitter element 113 in the laser output beam 50, the total power of the laser output beam 50 can be split specifically into the partial laser beams 51 and 52. For example, the first laser beam 51 can transport 30% of the energy of the laser output beam 50, while the second laser beam 52 can transport 70% of the energy of the laser output beam 50. The laser beams 51 and 52 are then focused onto the surface of the workpiece 100 to be coated via a focusing unit 114, in particular a focusing lens, and in doing so each produce a corresponding irradiation zone 101, 102 on the workpiece surface.

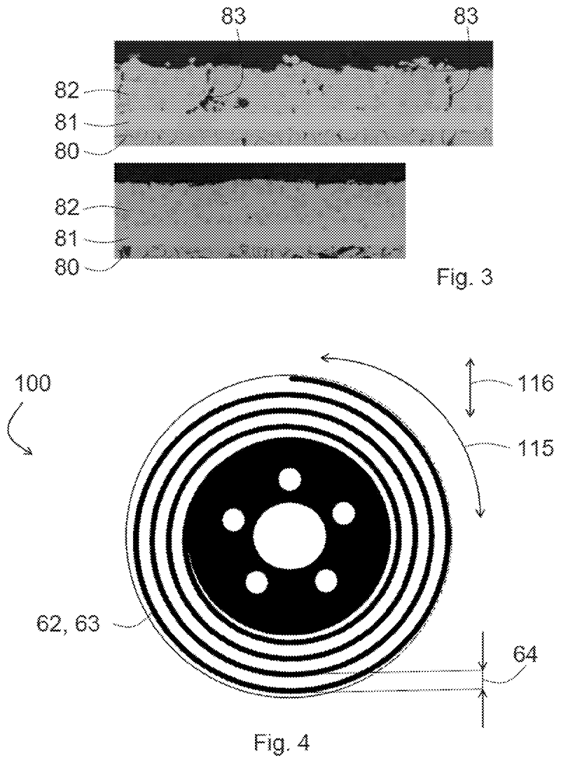

FIG. 3 shows a cross-section of the coating of a workpiece 100 coated by laser cladding. The workpiece 100 comprises a base body 80 and an intermediate layer 81 applied to the base body 80. A functional layer 82 is applied to the intermediate layer 81, which has powder particles embedded in a matrix material. The functional layer 82 comprises several overlapping powder-layer traces, as further described below. The functional layer 82 according to the upper illustration in FIG. 3 shows bonding defects 83 between the powder particles and the matrix. In the upper illustration, the primary laser energy exceeded the secondary laser energy during laser cladding. The coating process proposed here is intended to counteract the formation of bonding defects, as shown in the lower illustration in FIG. 3, where the secondary laser energy exceeded the primary laser energy during laser cladding.

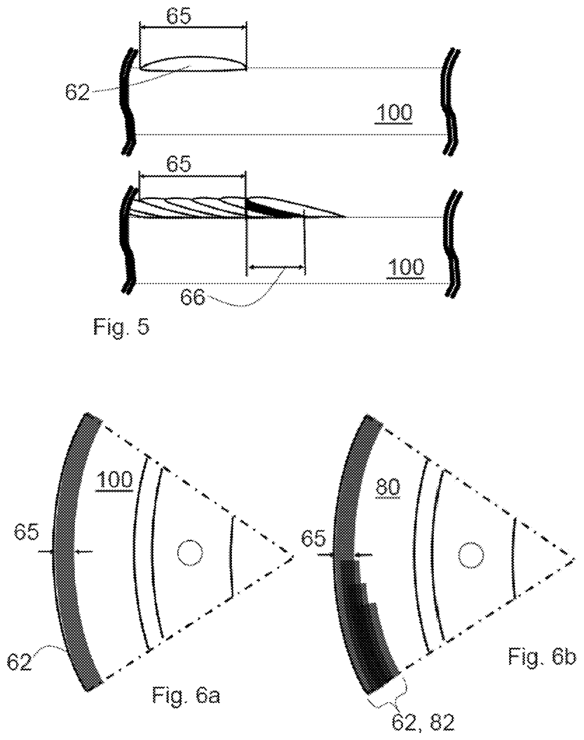

FIG. 4 shows the workpiece 100 in the form of a brake disk with a hub head. The brake disk is provided on a workpiece receiving unit that moves the workpiece 100 along a rotational movement 115. Furthermore, the workpiece receiving unit and/or the jet nozzle 1 is provided with a translation unit that causes a translational movement 116 of the jet nozzle and/or the workpiece receiving unit. The rotational movement 115 and the translational movement 116 combine to form a feed movement along the feed direction 2. In this process, a powder-layer trace 62 is applied to the workpiece along a spiral path 63. An offset 64 is present between two adjacent spiral flanks of the spiral path 63 due to the feed movement. The dimension of the offset 64 will be discussed further in connection with FIG. 5.

FIG. 5 shows the workpiece 100. In the upper image, a first powder-layer trace 62 having a trace width 65 was applied as a single trace. In the further course of the laser cladding process, the powder-layer trace 62 is applied to the workpiece 100 along the spiral path 63. The offset 64 of two adjacent spiral flanks is chosen such that it is less than the trace width 65, so that the powder-layer trace 62 forms a radial overlap 66 along the spiral path 63. The ratio of the trace width 65 to the offset 64 is 4 to 1 in the present example, so that in the lower image four partial traces are applied to the single trace from the upper image. The radial overlap 66, in combination with the disclosed division of the primary laser energy and the secondary laser energy, has the advantage that a previously applied powder-layer trace 62, for example the single trace from the upper image, is reheated when the overlapping trace is applied. This reheating promotes the solidification behavior of the applied functional layer 82 and results in a higher weld quality. The overlap 66 welds over a previously welded trace and remelts it in a favorable manner.

FIGS. 6a and 6b show the workpiece 100 in the form of a brake disk in a top view. In FIG. 6a, the powder-layer trace 62 is still a single trace. The powder-layer trace 62 has a trace width 65. In FIG. 6b, the laser cladding process has progressed further. In addition to the single trace shown in FIG. 6 a, three further traces are indicated which were applied to the workpiece 100 along the spiral path 63. The offset 64 of two adjacent spiral flanks of the spiral path 63 is smaller than the trace width 65. Accordingly, the radial overlap 66 is formed between adjacent spiral flanks; the ratio of the trace width 65 to the offset 64 can be greater than 2 to 1, for example 3 to 1 or 4 to 1. Once the entire spiral path 63 has been applied, the functional layer 82 covers the base body 80. In the case of the brake disk, the friction surface is provided as the base body 80 with the HS-LMD coating as a functional layer. This reduces the fine dust pollution that occurs in connection with a braking process.

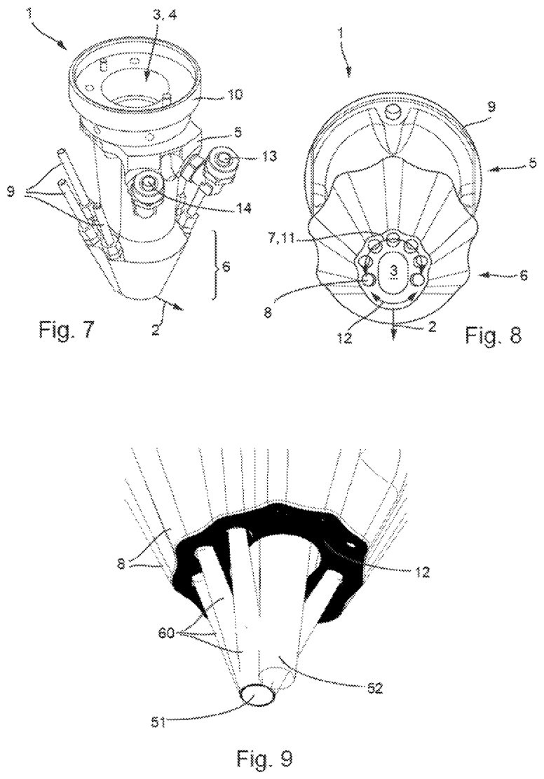

FIGS. 7 and 8 show an embodiment of the jet nozzle 1 for laser cladding along the feed direction 2. The laser output beam 50 emerges from the light channel 3 with the lateral surface 4. The light channel 3 can also be adapted to conduct a process protecting gas along a radially outer portion to protect a process zone and prevent oxidation. The light channel 3 is surrounded by an outer structure 5, which has the nozzle mouth 6, which in turn contains the powder unit 7. The powder unit 7 can, for example, have a plurality of injector guides 8, into each of which can be inserted a powder injector 9. As an alternative to the individual injector guides 8, the powder unit 7 can have an annular powder gap channel (not shown). The filler material 60 is directed at the workpiece 100 via the powder unit 7 and, for example, the powder injectors 9 arranged therein. The laser output beam 50 heats the workpiece 100 in such a way that a weld pool forms at least partially on a material surface. The disclosed division between the primary laser energy and the secondary laser energy contributes to avoiding the imperfections in the functional layer 82. The first laser beam 51 heats the filler material 60. As soon as the weld pool cools down, the welded-on functional layer 82, for example a wear protection layer, is formed from the hard material particles and the matrix material. The welded-on functional layer 82 makes the material surface more resistant and increases its load-bearing capacity.

A coupling ring 10 can be connected to a flange portion on the jet nozzle 1, which attaches the jet nozzle 1 to the connected unit, for example the laser optics 110 or the process adapter. The powder injectors 9 are inserted into the injector guides 8 of the powder unit 7. The filler material 60 is conveyed by means of the powder injectors 9 and applied to the workpiece 100 with the provided, adjustable, focus. The individual powder injectors 9 can use different powder foci in relation to each other. Alternatively, the powder injectors 9 can be directed to the same focus point. The powder injectors 9 are arranged in the provided injector guides 8 of the powder unit 7 in a powder portion 11. The powder portion 11 is followed in the peripheral direction by a powder unit-free feed portion 12, which is free of powder injectors 9. An inlet connection 13 is also inserted into a coolant inlet and an outlet connection 14 is inserted into the coolant outlet. These connect a coolant inlet and a coolant outlet of the jet nozzle to a coolant circuit of the laser system. The nozzle mouth 6 has a curved funnel shape. The injector guides 8, into which the powder injectors 9 can be inserted, are formed within the individual curvatures. In the feed direction 2, the light channel 3 is stretched in a manner deviating from a circular shape in order to conduct the first laser beam 51 and the second laser beam 52 in accordance with the disclosure and thus contribute to the advantages in accordance with the disclosure.

FIG. 9 shows the jet nozzle 1, from which the first laser beam 51 and the second laser beam 52 emerge. A powder jet emerges from each of the injector guides 8, which interacts with the first laser beam 51. The second laser beam 52 is used in accordance with the disclosure for preheating the workpiece surface. The second laser beam 52 is positioned upstream of the first laser beam 51 in the feed direction 2. To avoid an interaction between a powder jet and the second laser beam 52, the powder unit-free feed portion 12 is provided in the area of the nozzle mouth 6, in which no additional material 60 is conveyed to the workpiece surface. A cross-sectional area of the light channel 3 that is orthogonal to a longitudinal direction of the jet nozzle 1 deviates from a circular shape and is oblong in the feed direction 2. The extension facilitates the formation of the first irradiation zone 101 as a process zone and the second irradiation zone 102 as a preheating zone. In other words, orthogonal to the longitudinal direction, the jet nozzle 1 is a cross-section, part of which is the shape of the light channel 3. In the present case, this can extend in the feed direction 2 and can be axially symmetric along the feed direction 2 and point-symmetric about a center of the cross-section of the light channel 3. A minimum cross-sectional area of the light channel is determined by a dimension, in particular a diameter, of the laser beam. Compared to the minimum dimension, the cross-sectional area is oblong along the feed direction.

Insofar as applicable, all individual features presented in the exemplary embodiments can be combined with one another and/or interchanged.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Jet nozzle
2 Feed direction
3 Light channel
4 Lateral surface
5 Outer structure
6 Nozzle mouth
7 Powder unit
8 Injector guide
9 Powder injector
10 Coupling ring
11 Powder portion
12 Feed portion
13 Inlet connection
14 Outlet connection
50 Output laser beam
51 First laser beam
52 Second laser beam
60 Filler material
61 Weld bead
62 Powder-layer trace
63 Spiral path
64 Offset
65 Trace width
66 Radial overlap
80 Base body
81 Intermediate layer
82 Functional layer
83 Bonding defects
100 Workpiece
101 First irradiation zone
102 Second irradiation zone
110 Laser optics
111 Fiber-optic cable
112 Collimation unit
113 Beam splitter element
114 Focusing unit
115 Rotational movement
116 Translational movement

1. A method for laser cladding along a feed direction by a jet nozzle, the jet nozzle comprising a light channel for conducting at least one laser beam to be directed at a workpiece, and a powder unit for conducting at least one filler material, to be applied to the workpiece, the method comprising:
directing a first laser beam at the workpiece to produce a first irradiation zone and directing a second laser beam at the workpiece to produce a second irradiation zone, the second irradiation zone being upstream of the first irradiation zone in the feed direction; and
introducing the filler material into the first irradiation zone, the filler material at least partially entering the first laser beam before hitting the workpiece, and being at least partially heated as a result;
wherein the first laser beam introduces a primary laser energy into the first irradiation zone, and the second laser beam introduces a secondary laser energy into the second irradiation zone, the secondary laser energy being greater than the primary laser energy.

2. The method according to claim 1, wherein
the second laser beam has a higher laser power and/or a higher irradiation intensity and/or a larger cross-sectional area compared to the first laser beam.

3. The method according to claim 1, wherein
a ratio of the secondary laser energy to the primary laser energy is greater than 11:10.

4. The method according to claim 1, further comprising:
actuating a workpiece receiving unit, on which the workpiece is arranged, so as to cause a rotational movement of the workpiece about an axis of rotation; and
actuating a translation unit so as to cause a translational movement of the jet nozzle and/or the workpiece receiving unit in an offset direction substantially orthogonal to the axis of rotation;
wherein the rotational movement and the translational movement combine to form an advancing movement such that a powder-layer trace having a radial trace width is deposited onto the workpiece along a spiral path; and
wherein an offset of two adjacent spiral flanks of the spiral path is less than the trace width, such that the powder-layer trace forms a radial overlap along the spiral path.

5. The method according to claim 4, wherein
a ratio of the trace width to the offset is greater than 2:1.

6. The method according to claim 4, wherein
the radial overlap and the advancing movement are configured such that the second laser beam reheats a previously applied powder-layer trace when applying along the spiral path in order to promote a welding behavior by post-processing.

7. The method according to claim 1, wherein
the first laser beam and/or the second laser beam has a reduced intensity in a core region compared to a border region.

8. The method according to claim 1, wherein
the first laser beam and/or the second laser beam has a plateau-shaped intensity distribution.

9. The method according to claim 1, wherein
the first laser beam and the second laser beam are generated from a common laser output beam via beam splitting in a common optical unit.

10. The method according to claim 1, wherein
the first laser beam and the second laser beam are provided from two separate laser beam sources, wherein the second laser beam is supplied to the second irradiation zone outside the light channel.

11. The method according to claim 1, further comprising:
conducting a protective gas in the light channel, so that the first irradiation zone and/or the second irradiation zone is shielded from ambient oxygen.

12. The method according to claim 1, wherein
the introducing the filler material into the first irradiation zone is carried out by powder injectors.

13. A jet nozzle for laser cladding in a feed direction, the jet nozzle comprising:
a light channel for conducting at least one laser beam to be directed onto a workpiece; and
a powder unit located radially outside the light channel for conducting at least one filler material to be applied to the workpiece;
wherein the jet nozzle is configured to carry out the method according to claim 1.
